(19) United States
(12) Patent Application Publication
(10) Pub. No.: US 2016/0040560 A1
(43) Pub. Date: Feb. 11, 2016

(54) Power Generation by Converting Low Grade Thermal Energy to Hydropower

(71) Applicants: Aliasghar HARIRI, (US); Sahar HARIRI, (US)

(72) Inventors: Aliasghar Hariri, TORONTO (CA); Sahar Hariri, Toronto (CA)

(21) Appl. No.: 14/780,564

(22) PCT Filed: Aug. 9, 2013
(86) PCT No.: PCT/CA2013/050611

§ 371 Date: Sep. 28, 2015

(30) Foreign Application Priority Data
Apr. 2, 2013 (CA) 2811985
May 24, 2013 (CA) 2817610

(51) Int. Cl. F01K 27/00; F01K 21/00; F03B 3/12; F01K 25/08

(52) U.S. Cl. CPC F01K 27/005; F01K 25/08; F01K 21/00; F03B 3/12

(57) ABSTRACT

A low-grade heat power generation system method and devise characterized by converting an organic vapor pressure to a hydro fluid pressure for hydropower generation comprises an organic fluid circuit in thermal communication with a warm source and a cold source, as an organic vapor pressure supply, a vapor pressure to hydro pressure convertor unit comprises a plurality of pressure vessels in a direct conversion method and a reciprocating hydro pump in an indirect conversion method, where the pressurized organic vapor pressurizes a working hydro fluid, and a hydro fluid circuit, where the pressurized hydro fluid runs a hydro turbine to generate hydropower.

### TECHNICAL FIELD OF THE INVENTION

The presented invention relates to the field of thermodynamics and fluid mechanics, and more particularly, to low-grade heat recovery and power generation from a variety of thermal energy sources.

### BACKGROUND OF THE INVENTION

Low-grade heat is the thermal energy that is not easily convertible to other forms of energy, such as electricity, through the known means of power generation. Low-grade heat can be the waste heat of any processes in industrial, commercial and domestic settings, which is the residual heat of the system and the process that is often released in to the environment. Low-grade heat can also be of natural sources, such as solar, low grade geothermal, tropical and arctic ocean, and the aboveground and underground thermal energy. These abundant sources of thermal energy are promising energy sources capable of addressing, in part, the world's energy and environmental crisis.

Converting thermal energy to electric power by utilizing steam turbine is known as Rankin Cycle (RC). Organic Rankine Cycle (ORC) and its derivatives are the focus of academic and industrial medium-low grade heat power generation research and development. The design of Organic Rankine Cycle is very similar to that of the Steam Rankine Cycle where the working fluid, water, is replaced by an organic fluid with a much lower boiling point temperature. This replacement allows for the power generation cycle to function at a lower temperature range than what is required to bring water to its superheat temperature in a steam Rankine Cycle.

In Organic Rankin Cycle, a saturated organic vapor, which is heated by a warm source, runs a turbine. The turbine outlet vapor is condensed by a low temperature source and is returned to a warm liquid drum by using a liquid feed pump.

Utilizing saturated vapor to run a turbine is one of the main challenges of ORC such as; blade erosion and turbine inlet pressure drop due to saturated vapor condensation, limited minimum required temperature difference between warm and cold sources (25 Celsius minimum difference required temperature), turbine over size due to the turbine inlet low pressure and the efficiency of the steam turbine. Furthermore steam turbine is considered an expensive technology with high operation and maintenance associate costs.

There is a need present in the art for a system that is capable of efficiently, effectively and economically generate power from low-grade thermal energy of a wide range of heat sources.

### SUMMARY OF THE INVENTION

This invention relates to power generation from low-grade heat by converting saturated vapor pressure of an organic fluid to hydro pressure to run a hydro turbine for power generation.

Using saturated vapor pressure to pressurize a suitable fluid to run a hydro turbine is more efficient and cost effective than using saturated vapor to run a turbine.

The design of the invention comprises three main sections, the first section as the organic vapor pressure circuit, which supplies the saturated vapor pressure, the second section as the vapor pressure to hydro pressure convertor unit, which converts the vapor pressure to hydro pressure and the third section as the hydro fluid circuit, which converts the hydro fluid pressure to hydropower.

The organic vapor pressure circuit comprises a warm section and a cold section. The warm section comprises a pressure vessel, which contains a suitable organic fluid, at least one heat exchanger in thermal communication with at least a warm source. The heat exchanger/s in thermal communication with the warm source/s transfer the thermal energy from the heat source/s to the organic fluid in the pressure vessel of the warm section, causing the organic fluid to evaporate in to pressurized organic saturated vapor.

The cold section of the organic fluid circuit comprises at least one heat exchanger in thermal communication with at least one cold source, with temperature lower than that of the warm source/s, which condenses the returned low pressure organic vapor that is an outlet of the vapor pressure to hydro pressure convertor unit, at least one pressure vessel, which stores the condensed organic liquid for the purpose of mass and flow management, a liquid feed pump, which returns the condensed organic liquid to the pressure vessel of the warm section, and at least one heat exchanger for preheating the returned condensed organic liquid before it enters the pressure vessel of the warm section, to increase the efficiency of the system.

The design of the vapor pressure to hydro pressure convertor unit, which converts the saturated vapor pressure to hydro pressure, depends on the temperature difference between the warm and cold courses. Two preferred embodiments have been presented here as direct vapor pressure to hydro pressure convertor, and indirect pressure to hydro pressure convertor.

The direct vapor pressure to hydro pressure convertor unit is utilized when the temperature difference between the warm and cold sources can lead to organic vapor pressure and subsequently hydro pressure that is sufficient to efficiently run the hydro turbine of the hydro fluid circuit of the system. The direct vapor pressure to hydro pressure convertor unit comprises at least three pressure vessels, a plurality of valves in connection to the organic fluid circuit, and a plurality of check valves in connection to the hydro fluid circuit.

The top of the pressure vessels is connected to both the high-pressure line and the low-pressure line of the organic fluid circuit through valves. The bottom of the pressure vessels is also connected to both inlet and outlet of the hydro fluid circuit through an arrangement of the check valves.

The three mentioned pressure vessels, which are periodically filled with the outlet hydro fluid of the hydro fluid circuit, are periodically pressurized by saturated vapor pressure by being connected to the high-pressure line of the organic fluid circuit, through the three-way valves. In each cycle, one of the three pressure vessels that is full of the hydro fluid of the hydro fluid circuit is opened to the high-pressure vapor line of the organic fluid circuit and discharges one batch of high-pressure hydro fluid as the inlet of the hydro fluid circuit. When the hydro fluid is fully discharged from the pressurized vessel, the three-way valve switches the connection of the vessel from the high-pressure line to the low-pressure line of the organic fluid circuit to be depressurized and to discharge one batch of the organic vapor in to the low-pressure line of the organic fluid circuit. At the same time another one of the pressure vessels that is connected to the low-pressure line of the organic fluid circuit and has accumulated the outlet low-pressure hydro fluid of the hydro fluid circuit is connected to the high-pressure vapor line through a valve, which now will be pressurized to perform the vapor pressure to hydro pressure conversion.

In other words, at the beginning of each cycle, one pressure vessel is being pressurized by being connected to the high-pressure line of the organic fluid circuit and is pressurizing and discharging its previously accumulated hydro fluid as inlet of the hydro fluid circuit, the second pressure vessel, which has previously discharged its hydro fluid is depressurizing by being connected to the low-pressure line of the organic fluid circuit, and the third pressure vessel, which has previously been depressurized by being connected to the low-pressure line of the organic fluid circuit is receiving the low-pressure hydro fluid outlet of the hydro fluid circuit. This cycle is repeated continuously, which provides a continuous inlet of high-pressure hydro fluid for the hydro fluid circuit.

When utilizing the direct convertor unit a pressure balance line connects the outlet chamber of the hydro turbine of the hydro fluid circuit to the cold section of the organic fluid circuit, for the purpose of equalizing the outlet pressure of the hydro turbine with the low vapor pressure of the cold section of the organic vapor circuit.

Alternative embodiments of the pressure vessel of the direct vapor pressure to hydro pressure convertor unit are bladder type pressure vessels with rubber membrane separator, and alternatively pistons and cylinders. In these alternative embodiments there is no contact between the organic vapor of the organic fluid circuit and the hydro fluid of the hydro fluid circuit.

The indirect vapor pressure to hydro pressure convertor unit is utilized when the temperature difference between the warm and cold sources and the resulting organic vapor pressure and subsequently hydro pressure are not sufficiently high enough to efficiently run the hydro turbine of the hydro fluid circuit. In this indirect conversion a multi cylinder hydro pump is utilized, which boosts and increases the hydro pressure when converting the organic vapor pressure to hydro pressure.

The multi cylinder hydro pump is a new design, which converts and boosts any low-pressure vapor, liquid, steam or air to any required hydro pressure. One preferred embodiment of the multi cylinder hydro pump comprises a vapor section and a hydro section. The vapor section comprises assembly of a series of vapor cylinders, a plurality of vapor pistons, a piston rod, a plurality of sleeves as piston spacers, and a four-way valve. The hydro section comprises a cylinder, a piston, and a plurality of check valves.

As the vapor pressure to hydro pressure convertor unit of the thermal energy to hydropower system, the vapor section of the multi cylinder hydro pump is connected to both the high-pressure vapor and low-pressure vapor lines of the organic fluid circuit through a four-way valve. This is while the hydro section of the multi cylinder hydro pump is connected to the inlet and the outlet of the hydro fluid circuit.

Both sides of all the cylinders of the vapor section are connected to both the high-pressure line and the low-pressure line of the organic fluid circuit through the four-way valve. By connecting one side of all the said pistons to the high-pressure vapor line of the organic fluid circuit, while the other side of all the said pistons are connected to the low-pressure line of the organic fluid circuit through the four-way valve, the saturated vapor pressure exerts force on the pistons, where the sum of the exerted forces on the pistons of the vapor section will be transferred to the piston rod, the said force is then transferred to the piston of the hydro section of the multi cylinder hydro pump, which pressurizes the hydro fluid, which is then discharged as the inlet of the hydro fluid circuit. The multi cylinder hydro pump works as a reciprocating hydro pump by periodically switching the connections of its vapor section between the high-pressure vapor line and the low-pressure vapor line of the organic fluid circuit.

The number of the series of the pistons and cylinders of the vapor section of the multi cylinder hydro pump depends on the temperature difference between the warm and the cold sources and consequently the pressure difference between the warm and the cold sections of the organic fluid circuit of the system, where the design can range from one to many pistons and cylinders of the vapor section, based on the required hydro pressure to run the hydro turbine efficiently. The ratio between the diameters of the pistons of the vapor section to that of the hydro section of the multi cylinder pump is another feature of the design that can increase the resulting hydro pressure, being the outlet of the multi cylinder hydro pump.

An alternative embodiment of indirect vapor pressure to hydro pressure convertor unit utilizes multi diaphragm hydro pump as a new design, which utilizes diaphragms and pressure chambers instead of pistons and cylinders of the vapor section of the multi cylinder hydro pump.

In the indirect vapor pressure to hydro pressure conversion, the multi cylinder/diaphragm hydro pump is insulated and preheated by at least one heat exchanger in thermal communication with the warm source/s to prevent saturated vapor condensation.

The hydro fluid circuit comprises mainly of a hydro turbine where the remainder of the components depend on whether the direct or indirect vapor pressure to hydro pressure convertor system is being used.

When direct vapor pressure to hydro pressure convertor unit is utilized, the hydro fluid circuit comprises a hydro turbine, a fluid circulation pump and at least one heat exchanger in thermal communication with the warm source/s. High-pressure hydro fluid as an outlet of the vapor pressure to hydro pressure convertor unit is the inlet of this section, which runs the hydro turbine. Low-pressure hydro fluid, as the discharge of the hydro turbine is pumped by the circulation pump, passing through the heat exchanger along the way, as the outlet of the hydro fluid circuit and the inlet of the vapor pressure to hydro pressure convertor unit. The heat exchanger is for the purpose of preheating the hydro fluid to prevent condensation of the saturated organic vapor, when it comes in contact with the organic vapor in the vapor pressure to hydro pressure convertor unit.

When indirect vapor pressure to hydro pressure convertor unit is utilized, the hydro fluid circuit comprises a hydro turbine and there is no need for the circulation pump in this embodiment, as the multi cylinder/diaphragm hydro pump accommodates the circulation of the hydro fluid. Furthermore there is no need to the preheating heat exchanger/s as there is no thermal communication between the organic vapor and the hydro fluid.

An alternative embodiment of the organic fluid circuit is utilized when the warm source/s of the system contains a refrigeration circuit comprising of an expansion valve, an evaporator, compressor and a condenser as its main components. Examples of this warm source would be any refrigerant system.

In this alternative embodiment, the said condenser of the refrigerant system is eliminated, where the outlet of the compressor of the refrigerant system, which is a superheat organic vapor, is transferred in to the pressure vessel of the warm section of the organic fluid circuit, while passing through at least one heat exchanger, which is in thermal communication with the organic liquid of the pressure vessel of the warm section.

The organic liquid in the pressure vessel of the warm section absorbs the extra latent heat of the superheat organic vapor through the said heat exchanger/s and evaporates the organic liquid, while the superheat organic vapor converts in to saturated vapor. The sum of both the transferred and the generated saturated vapor of the pressure vessel of the warm section are transferred to the vapor pressure to hydro presser convertor unit.

In this alternative embodiment of the organic fluid circuit the returned organic vapor as the outlet of the vapor section of the vapor pressure to hydro pressure convertor unit, which is condensed in the cold section of the organic fluid circuit is transferred to the expansion valve of the organic refrigerant system to be expanded in the evaporator.

The portion of the condensed organic liquid of the cold section, relating to the saturated vapor generated as the result of thermal communication between the organic liquid in the pressure vessel of the warm section and the superheat organic vapor, is transferred to the pressure vessel of the warm section through the liquid feed pump. This liquid mass transfer is to preserve the mass balance of the organic fluid circuit.

In this alternative embodiment, it is also possible to eliminate the pressure vessel of the warm section as well as its associated heat exchanger/s, where the superheat organic vapor of the outlet of the compressor is the direct inlet of the vapor pressure to hydro pressure convertor. By eliminating the pressure vessel of the warm section, there is no need for the liquid feed pump, which can hence be eliminated from the circuit.

### BRIEF DESCRIPTION OF THE DRAWINGS

FIG. 1 is a schematic drawing of the heat to hydropower generation system

FIG. 2 is a schematic drawing of the heat to hydropower generation system utilizing the direct vapor pressure to hydro pressure convertor

FIG. 3 is a schematic drawing of the heat to hydropower generation system utilizing the indirect vapor pressure to hydro pressure convertor

FIG. 4 is a schematic drawing of the multi cylinder hydro pump

FIG. 5 is a schematic drawing of the multi diaphragm hydro pump

FIG. 6 is a schematic drawing of the heat to hydropower generation system with an alternative embodiment of the organic fluid circuit, utilizing components of a refrigeration system.

FIG. 7 is a schematic drawing of the heat to hydropower generation system with an alternative embodiment of the organic fluid circuit, utilizing components of a refrigeration system, while eliminating the pressure vessel and the heat exchanger of the warm section and the feed pump of the cold section.

### DETAILED DESCRIPTION OF PREFERRED AND ALTERNATE EMBODIMENTS

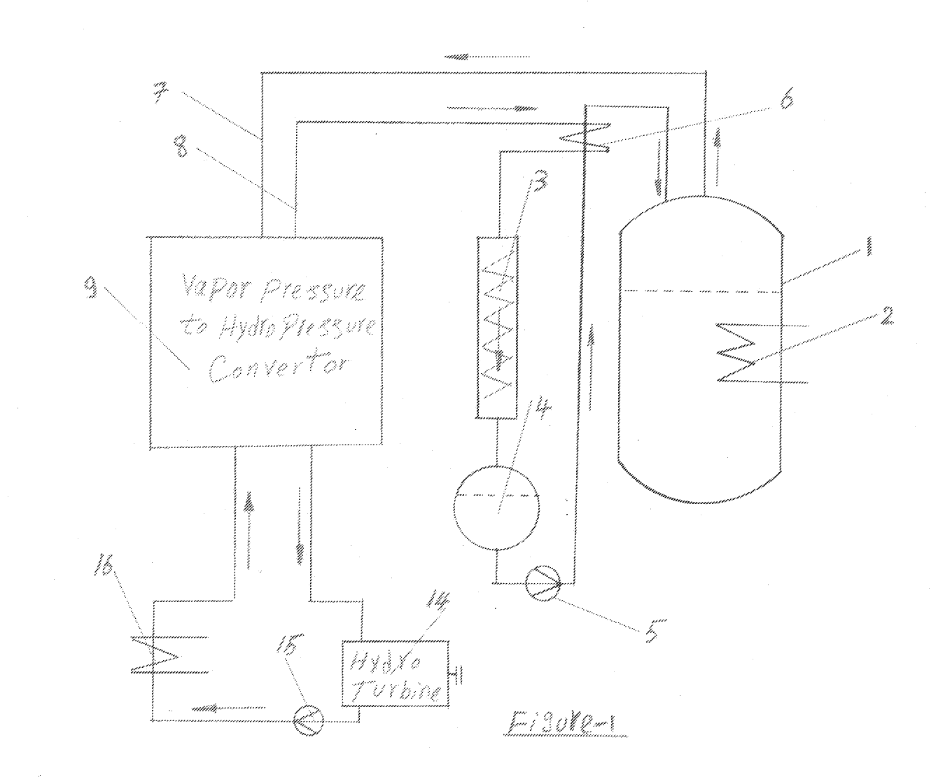

The design of the invention, illustrated in FIG. 1, which converts low-grade thermal energy to the hydropower, comprises three main sections, the first section as the organic fluid circuit, which supplies saturated vapor pressure, the second section as the vapor pressure to hydro pressure convertor unit, which converts the saturated vapor pressure to fluid pressure, and the third section as the hydro fluid circuit, which converts the fluid pressure to the hydropower.

The organic fluid circuit, illustrated in FIG. 1, comprises a warm section and a cold section. The warm section comprises a pressure vessel 1, which contains a suitable organic liquid and a heat exchangers 2, which transfers the thermal energy from a heat source/s to the organic liquid in pressure vessel 1 of the warm section. The cold section of the organic fluid circuit, comprises a heat exchanger 3, which condenses the returned low pressure vapor, the pressure vessel 4, which stores the condensed organic liquid, a liquid feed pump 5, which transfers the condensed organic liquid to the pressure vessel 1 of the warm section and a heat exchanger 6, which preheats the returned condensed organic liquid to the pressure vessel 1 of the warm section.

The thermal energy is transferred from the heat source/s to the organic liquid in the pressure vessel 1 of the warm section and keeps its temperature and consequently the saturated vapor pressure at the maximum achievable pressure. By transferring the thermal energy to the pressure vessel 1 of the warm section through the heat exchanger 2, the organic fluid circuit works as the saturated vapor pressure supply.

The design of the vapor pressure to hydro pressure convertor unit, which converts the saturated vapor pressure to the fluid pressure, depends on the temperature difference between the warm and cold sources and is designed in two versions namely; direct vapor pressure to hydro pressure convertor unit and indirect vapor pressure to hydro pressure convertor unit.

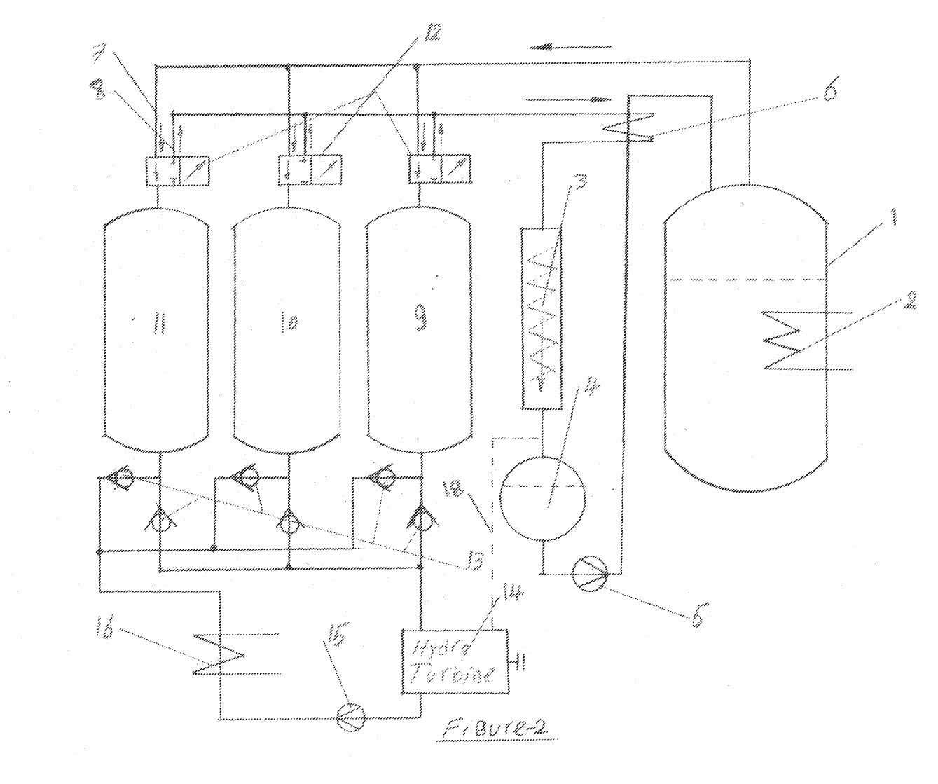

The direct vapor pressure to hydro pressure unit is utilized when the temperature difference between the warm and cold sources is sufficiently high to run the hydro turbine efficiently. FIG. 2 illustrates the process of converting low-grade energy to the hydropower by utilizing the design of the direct vapor pressure to the hydro pressure convertor, which directly converts saturated vapor pressure to hydro pressure.

The direct vapor pressure to hydro pressure unit, which is shown in FIG. 2, comprises pressure vessels 9, 10, 11, three-way valves 12 and check valves 13. The top of the pressure vessels 9, 10 and 11 are connected to both the high-pressure vapor line 7, and the low-pressure vapor line 8, through the three-way valves 12. The bottom of pressure vessels 9, 10, and 11 are connected to the inlet and outlet of the hydro fluid circuit through the check valves 13.

The pressure vessels 9, 10 and 11, which are periodically filled by the returned fluid from the outlet of the hydro fluid circuit, are periodically pressurized by the saturated vapor pressure through the three-way valves 12, to run the hydro turbine 14, continuously.

In each cycle, one of the pressure vessels 9, 10, and 11, which is connected to the saturated vapor pressure line 7, through the three-way valve 12, is discharging its fluid and running the hydro fluid circuit. When the fluid in the pressurized vessel reaches its minimum level, the related three-way valve 12, switches the connection of the pressurized vessel from the high-pressure vapor line 7, to the low-pressure vapor line 8, to be depressurized. At the same time another pressure vessel, which is connected to the low-pressure vapor line 8, through the three-way valve 12, and is already filled with the returned fluid from the outlet of the hydro fluid circuit through the fluid circulation pump 15, will be pressurized by connecting to the high-pressure vapor line 7 through the related three-way valve 12.

In other words in each cycle, one fluid pressure vessel, which is already pressurized by saturated vapor is running the hydro turbine 14, the second fluid pressure vessel which already its fluid was discharged is depressurizing through the low pressure vapor line 8, and the third fluid pressure vessel which already was depressurized is receiving the returned fluid from the hydro turbine 14 to be ready to be pressurized for the next cycle. This cycle will be repeated and the hydro turbine 14, works continually based on pressure difference between the warm and cold sections, which is converted to the fluid pressure.

In an alternative embodiment of the direct pressure vessel of the vapor pressure to hydro pressure convertor unit, to prevent the organic liquid from being exposed to the fluid in the fluid pressure vessels 9, 10, and 11, rubber separators are used in the bladder type pressure vessels, or cylinders and pistons are used instead of pressure vessels to convert the saturated vapor pressure to the fluid pressure.

In direct conversion of saturated vapor pressure to the hydropower, all components are insulated and the fluid in the hydro fluid circuit is preheated in thermal communication with the warm source/s through heat exchanger 16 to prevent any chance of saturated vapor condensation.

When utilizing the direct convertor unit a pressure balance line 18 connects the outlet chamber of the hydro turbine 14 of the hydro fluid circuit to the cold section of the organic fluid circuit, for the purpose of equalizing the outlet pressure of the hydro turbine 14 with the low vapor pressure of the cold section of the organic vapor circuit.

The indirect vapor pressure to hydro pressure convertor is utilized when the temperature difference between the warm and cold sources is not sufficiently high to generate the required hydro pressure to run the hydro turbine efficiently.

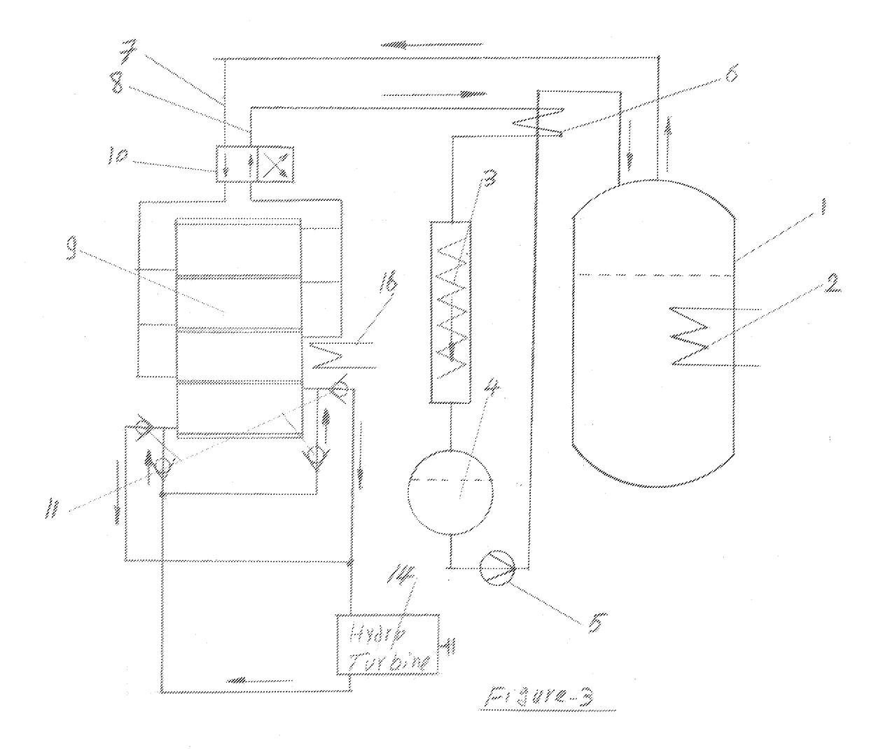

FIG. 3 illustrates the process of converting the low-grade energy to the hydropower by utilizing multi cylinder hydro pump, which converts indirectly the saturated vapor pressure to the required fluid pressure.

The multi cylinder hydro pump is a new design, which converts indirectly any low-pressure medium as; vapor, liquid, steam and air to the any required fluid pressure. As FIG. 3 illustrates, by connecting the both high-pressure vapor line 7 and low-pressure vapor line 8 to the multi cylinder hydro pump 9, the saturated vapor pressure is indirectly converted to the hydro fluid pressure.

The multi cylinder hydro pump 9 is designed based on temperature difference between the warm and cold sources and converts indirectly the saturated vapor pressure to the required hydro fluid pressure.

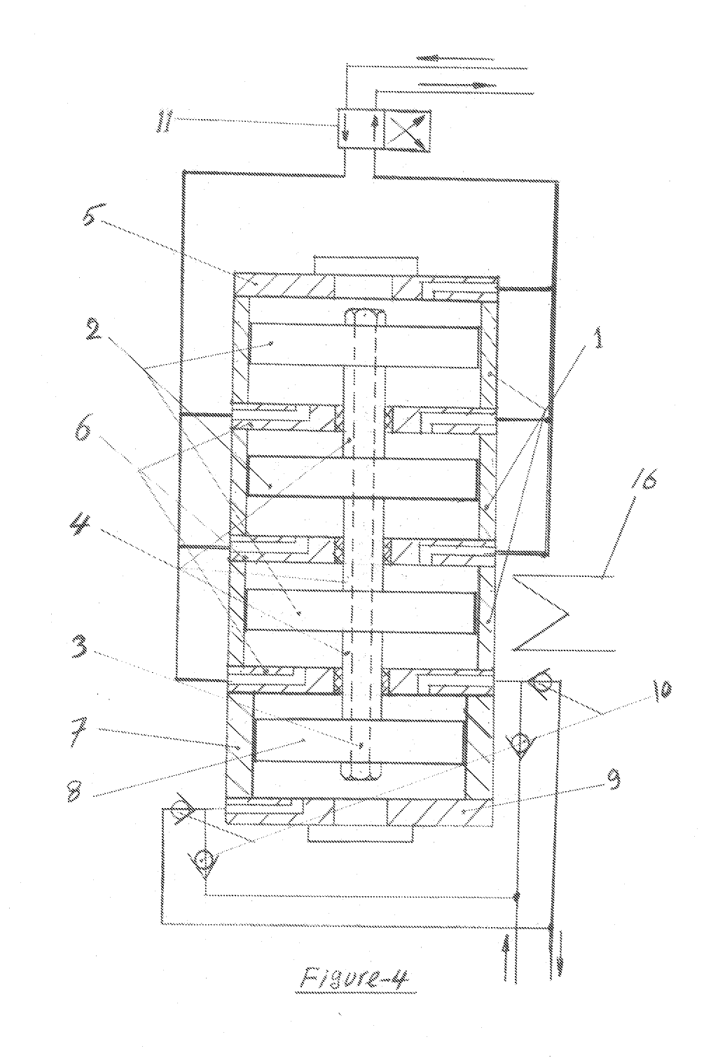

FIG. 4 illustrates a multi cylinder hydro pump, which comprises two sections, a vapor section, which works as the saturated vapor power supply and a hydro section as the fluid pressure supply. The vapor section comprises an assembly of a plurality of vapor cylinders 1, a plurality of vapor pistons 2, pistons assembling rod 3, a plurality of sleeves as pistons spacers 4, a cylinders cap 5, a plurality of cylinder spacers 6 and a four-way valve 11.

The hydro section comprises a hydro cylinder 7, a hydro piston 8, a cylinder cap 9 and a plurality of check valves 10.

The number of the series of the vapor cylinder/s 1 and piston/s 2 in the vapor section depends on the temperature difference and consequently the pressure difference between the warm and cold sources and could be designed with one vapor piston or the required number of pistons based on the required hydro pressure. The ratio between the diameter of the vapor piston/s 2 and the diameter of the hydro piston 8 is another factor for increasing the hydro pressure and achieving a hydro pressure greater that the inlet vapor pressure.

By connecting the vapor section of the multi cylinder hydro pump to both the saturated vapor pressure line 7 and the low pressure vapor line 8 through the four-way valve 11, the saturated vapor pressure is transferred to the one side of the vapor piston/s 2, while the other side of the vapor pistons are connected to the low pressure vapor line 8. The saturated vapor pressure in vapor cylinders 1 is converted to force exerted on the piston/s 2. The sum of the piston/s force/s is transferred to the piston 8 in the hydro pump through the assembled piston spacers 4 and piston rod 3 and is converted to the required hydro pressure.

The multi cylinder hydro pump works as a reciprocating hydro pump by connecting to the high pressure line and low-pressure vapor lines of the organic vapor circuit, through the four-way valve 11 or any other valve, which connects periodically the vapor section to the high and low vapor pressure lines of the organic fluid circuit.

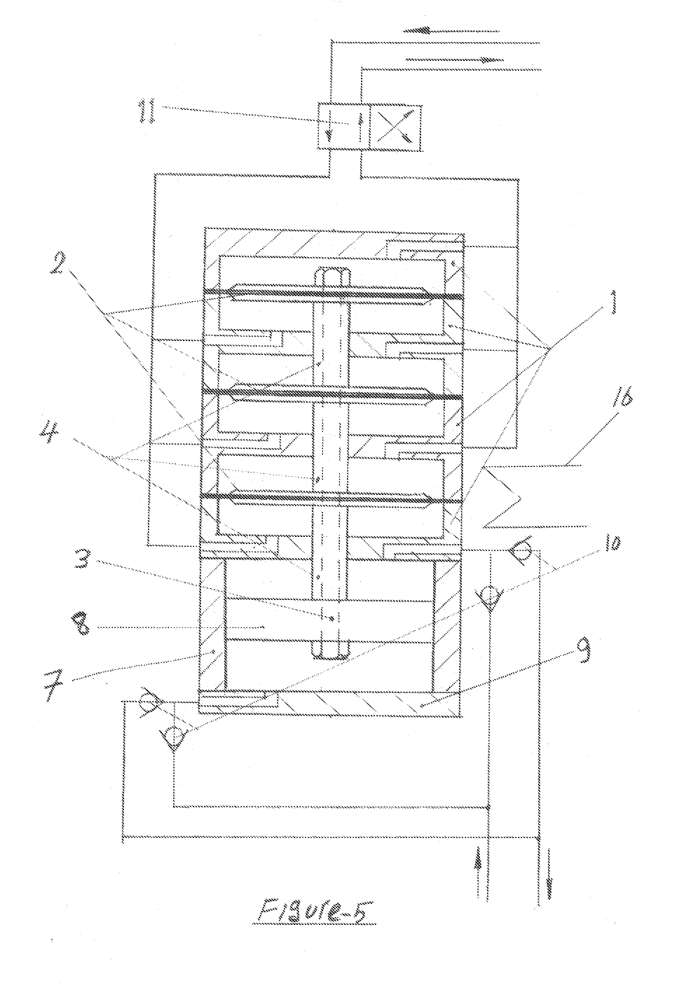

FIG. 5 illustrates a multi diaphragm hydro pump, which directly converts saturated vapor pressure to hydro pressure.

The multi diaphragm hydro pump comprises two sections, a vapor section and a hydro section. The vapor section comprises, a plurality of vapor pressure chambers 1, a plurality of diaphragms 2, a diaphragm connecting rod 3, a plurality of sleeves as diaphragm spacers 4, and the four-way valve 11. The hydro section comprises, a hydro cylinder 7, a hydro piston 8, a cylinder cap 9 and a plurality of check valves 10.

In indirect converting of saturated vapor pressure to the hydropower, all components are insulated and the vapor sections of the multi cylinder and the multi diaphragm hydro pump are preheated in thermal communication with the warm source/s through the heat exchanger 16, to prevent any possibility of saturated vapor condensation.

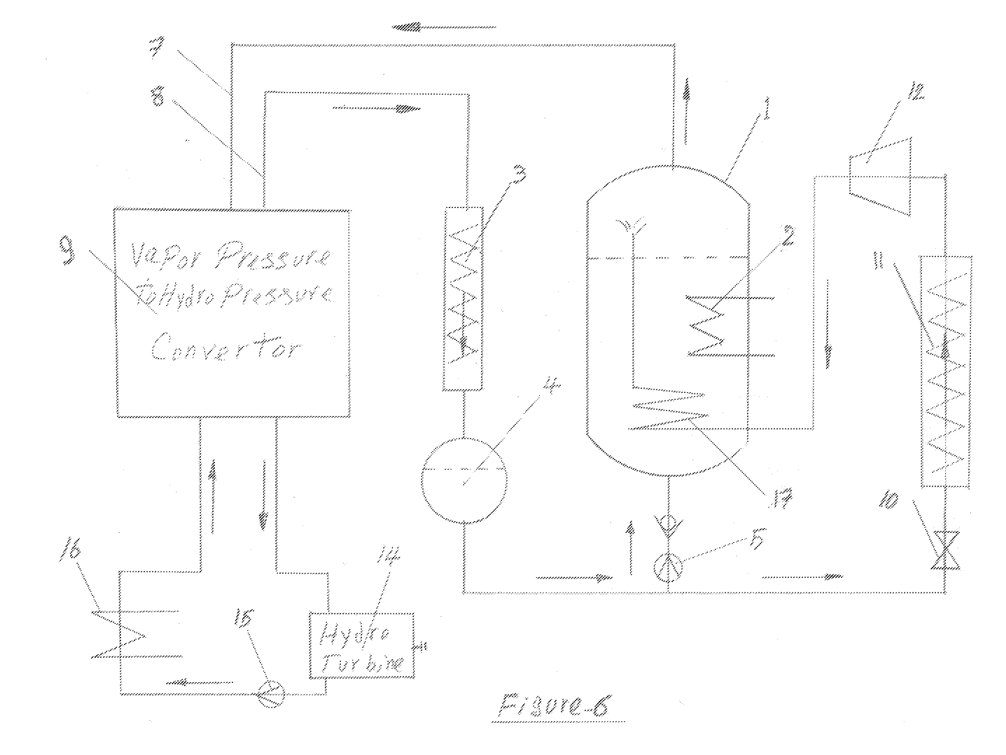

FIG. 6 illustrates an alternative embodiment of organic fluid circuit of the thermal energy to hydropower system, which may be utilized when the warm source/s contain a refrigeration organic fluid circuit. This embodiment combines the refrigeration circuit with the organic fluid circuit of the thermal energy to hydropower system, where the condenser of the refrigerant circuit is eliminated.

This embodiment further comprises an expansion valve 10, an evaporator 11, a refrigerant compressor 12, and a heat exchanger 17 in thermal communication with the organic fluid of the pressure vessel of the warm section.

The outlet of the compressor 12, which is superheat organic vapor is transferred in to the pressure vessel 1 of the warm section of the organic fluid circuit, while passing thought the heat exchanger 17, which is in thermal communication with the organic liquid of the pressure vessel 1 of the warm section.

The organic liquid in the pressure vessel 1 absorbs the extra latent heat of the superheat organic vapor through the heat exchanger 17, which is in thermal communication with the organic liquid of the pressure vessel 1, and evaporates the organic liquid in the pressure vessel 1, while the superheat organic vapor converts in to saturated vapor.

The sum of both the transferred and the generated saturated vapor of the pressure vessel 1 of the warm section are transferred to the vapor pressure to hydro pressure convertor unit 9 through a high-pressure vapor line 7.

The returned organic vapor as an outlet of the vapor pressure to hydro pressure convertor unit 9 is transferred to heat exchanger 3 through the low pressure vapor line 8, to be condensed and stored in the condensed pressure vessel 4 to be transferred to expansion valve 10 to be expanded in the evaporator 11. The expanded organic vapor is then transferred to the refrigerant compressor 12, to be compressed as a superheat organic vapor as the outlet of compressor 12.

The portion of the condensed organic liquid of the cold section relating to the saturated vapor generated as a result of thermal communication between the organic liquid of the pressure vessel 1 and the superheat organic vapor as the outlet of the compressor 12 is transferred to the pressure vessel 1, through the liquid feed pump 5. This liquid mass transfer is to preserve the mass balance of this alternative embodiment of the organic fluid circuit.

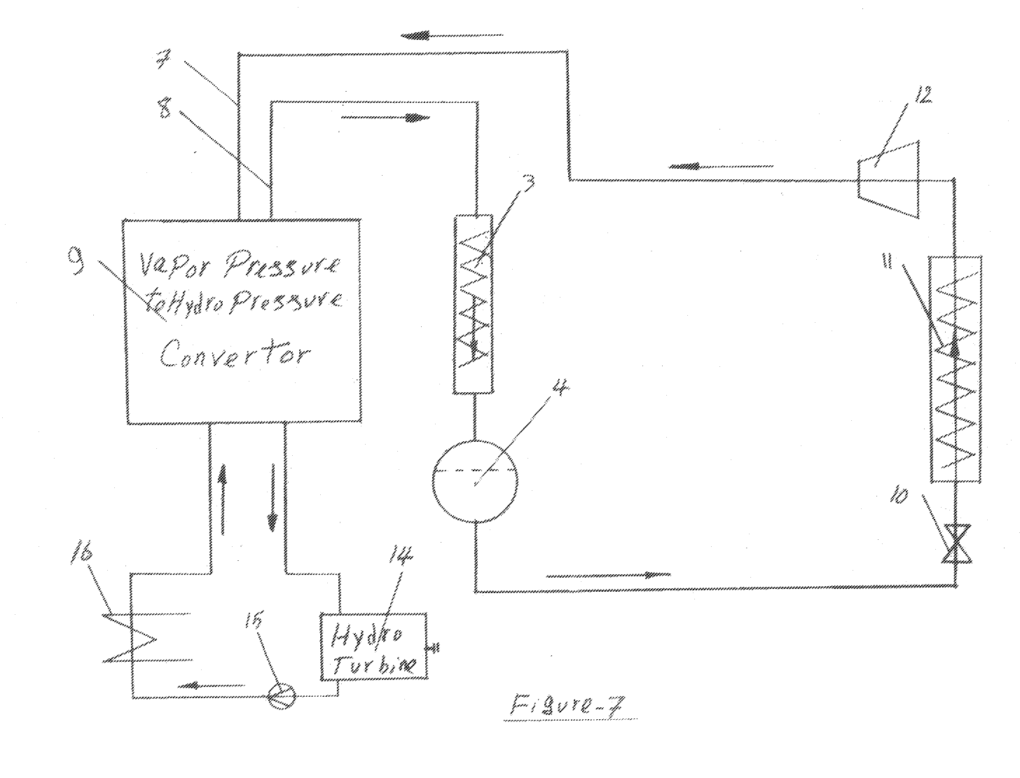

FIG. 7 illustrates a further alternative embodiment, where the pressure vessel 1 as well as its associated heat exchanger 17 and heat exchanger 2 of FIG. 6 have been eliminated. The superheat organic vapor of the outlet of the compressor 12 is the direct inlet of the vapor pressure to hydro pressure convertor unit 9, through the high-pressure vapor line 7.

The returned organic vapor as an outlet of the vapor pressure to hydro pressure convertor unit 9 is transferred to heat exchanger 3 through a low pressure vapor line 8, to be condensed and stored on condensed pressure vessel 4 to be transferred to expansion valve 10 to be expanded in the evaporator 11. The expanded organic vapor is then transferred to the refrigerant compressor 12, to be compressed as a superheat organic vapor as the outlet of compressor 12. Here the liquid feed pump 5 of FIG. 6 is also eliminated.

Although the invention has been illustrated and described in connection with the selected embodiments, it should be understood that one skilled in the art and with access to the presented teachings can make modifications, additions and alternations to the invention without departing from the spirit and scope of the present invention.

What is claimed is:

1. A thermal energy to hydropower system functioning to perform a thermodynamic cycle containing an organic fluid and a hydrodynamic cycle containing a working hydro fluid, the thermal energy to hydropower system comprises,
an organic fluid circuit having a warm section and a cold section, and an organic fluid contained in the organic fluid circuit;
a pressure vessel in the organic fluid circuit containing saturated organic liquid;
a heat exchanger in the organic fluid circuit in thermal communication with a heat source,
whereby thermal energy is transferred to the organic liquid in the pressure vessel of the warm section;
a vapor pressure to hydro pressure convertor unit connecting the organic fluid circuit and the hydro fluid circuit and operative to convert organic fluid pressure of the organic circuit to hydro fluid pressure of the hydro fluid circuit;
a heat exchanger in the organic fluid circuit in thermal communication with a cold source and in thermal communication with the organic fluid in the cold section;
a mass balance system in the cold section of the organic fluid circuit, having a storage pressure vessel;
a mass balance system in the cold section of the organic fluid circuit, having a pump to circulate the organic fluid of the organic fluid circuit;
a hydro turbine in the hydro fluid circuit operative to convert hydro fluid pressure to hydropower.

2. The thermal energy to hydropower system of claim 1, wherein the pressure vessel of the warm section of the organic fluid circuit contains the organic fluid in a saturated state.

3. The thermal energy to hydropower system of claim 2, wherein the pressure vessel of the warm section of the organic fluid circuit operates as saturated vapor pressure supply.

4. The thermal energy to hydropower system of claim 1, wherein the heat exchanger of the warm section of the organic fluid circuit transfers the thermal energy from the warm source to the organic fluid of the organic fluid circuit.

5. The thermal energy to hydropower system of claim 1, wherein the heat exchanger of the cold section of the organic fluid circuit transfers the thermal energy from the organic fluid of the organic fluid circuit to the cold source.

6. The thermal energy to hydropower system of claim 1, wherein the pump of the cold section of the organic fluid circuit transfers the organic fluid of the storage pressure vessel of the cold section to the pressure vessel of the warm section of the organic fluid circuit.

7. The vapor pressure to hydro pressure convertor unit of claim 1, wherein the organic vapor pressure is directly converted to hydro pressure.

8. The vapor pressure to hydro pressure convertor unit of claim 7, comprises a plurality of pressure vessels, a plurality of valves in connection between the said pressure vessels and the organic fluid circuit, and a plurality of check valves in connection between the said pressure vessels and the hydro fluid circuit.

9. The vapor pressure to hydro pressure convertor unit of claim 7, comprises a plurality of bladder type pressure vessels containing rubber separators, a plurality of valves in connection between the said pressure vessels and the organic fluid circuit, and a plurality of check valves in connection between the said pressure vessels and the hydro fluid circuit.

10. The vapor pressure to hydro pressure convertor unit of claim 9, wherein said rubber separators separate the organic vapor of the organic fluid circuit from the hydro fluid of the hydro fluid circuit.

11. The vapor pressure to hydro pressure convertor unit of claim 7, comprises a plurality of cylinders and pistons, a plurality of valves in connection between the said pressure vessels and the organic fluid circuit, and a plurality of check valves in connection between the said pressure vessels and the hydro fluid circuit.

12. The vapor pressure to hydro pressure convertor unit of claim 11, wherein said pistons separate the organic vapor of the organic fluid circuit from the hydro fluid of the hydro fluid circuit.

13. The vapor pressure to hydro pressure convertor unit of claim 7, wherein the said pressure vessels are pressurized by connecting to the saturated vapor of the organic fluid circuit to pressurize the hydro fluid in the said pressure vessels, periodically.

14. The vapor pressure to hydro pressure convertor unit of claims 7 and 13, wherein a pair of check valves per pressure vessel manages the inlet and outlet flow of each of the pressure vessels and the hydro fluid circuit.

15. The thermal energy to hydropower system of claim 1, further comprises a circulation pump as a component of the hydro fluid circuit to perform hydro fluid mass balance management, when direct vapor pressure to hydro pressure convertor is utilized.

16. The thermal energy to hydropower system of claim 1, further comprises a heat exchanger as a component of the hydro fluid circuit, when direct vapor pressure to hydro pressure convertor unit is utilized.

17. Thermal energy to hydropower system of claim 16, wherein the said heat exchanger preheats the hydro fluid of the hydro fluid circuit in thermal communication with the heat source to prevent condensation of the organic saturated vapor in the said pressure vessels, when direct vapor pressure to hydro pressure convertor is utilized.

18. The vapor pressure to hydro pressure convertor unit of claim 1, wherein the organic vapor pressure is indirectly converted to hydro pressure.

19. The vapor pressure to hydro pressure convertor unit of claim 18 comprises a vapor section and a hydro fluid section.

20. The vapor pressure to hydro pressure convertor unit of claim 19, wherein the said vapor section comprises a plurality of pistons and cylinders assembled in series.

21. The vapor pressure to hydro pressure convertor unit of claim 18, wherein the said hydro section comprises a cylinder and a piston.

22. The vapor pressure to hydro pressure convertor unit of claim 18, further comprises a piston rod and a plurality of sleeves as piston spacers.

23. The vapor pressure to hydro pressure convertor unit of claims 18 and 22, wherein the said pistons of the vapor section and the piston of the hydro fluid section are assembled by the piston rod and the plurality sleeves as piston spacers.

24. The vapor pressure to hydro pressure convertor unit of claim 23, wherein the saturated vapor pressure of the warm section of the organic fluid circuit is transferred to one side of all the pistons of the vapor section, while the other side of the pistons of the vapor section are connected to the cold section of the organic fluid circuit.

25. The vapor pressure to hydro pressure convertor unit of claim 24, wherein the said saturated vapor pressure exerts force on all the said pistons of the vapor section.

26. The vapor pressure to hydro pressure convertor unit of claims 24 and 25, wherein the sum of the said exerted forces is transferred to the piston of the hydro section through the piston rod, which exerts the said force to the hydro fluid of the hydro section as hydro pressure.

27. The vapor pressure to hydro pressure convertor unit of claim 19, wherein the said vapor section comprises a plurality of diaphragms and pressure chambers assembled in series.

28. The vapor pressure to hydro pressure convertor unit of claim 18, wherein the said hydro section comprises a cylinder and a piston.

29. The vapor pressure to hydro pressure convertor unit of claim 18, further comprises a diaphragm rod and a plurality of sleeves as diaphragm spacers.

30. The vapor pressure to hydro pressure convertor unit of claims 18 and 29, wherein the said diaphragms of the vapor section and the piston of the hydro fluid section are assembled by the piston rod and the plurality sleeves as diaphragm spacers.

31. The vapor pressure to hydro pressure convertor unit of claim 30, wherein the saturated vapor pressure of the warm section of the organic fluid circuit is transferred to one side of all the diaphragms of the vapor section, while the other side of the diaphragms of the vapor section are connected to the cold section of the organic fluid circuit.

32. The vapor pressure to hydro pressure convertor unit of claim 31, wherein the said saturated vapor pressure exerts force on all the said diaphragms of the vapor section.

33. The vapor pressure to hydro pressure convertor unit of claims 31 and 32, wherein the sum of the said exerted forces is transferred to the piston of the hydro section through the diaphragm rod, which exerts the said force to the hydro fluid of the hydro section as hydro pressure.

34. The vapor pressure to hydro pressure convertor unit of claim 18, wherein two pairs of check valves manage the inlet and outlet hydro flow of the hydro section.

35. The thermal energy to hydropower system of claim 1, wherein an alternative embodiment of the organic fluid circuit further comprises an expansion valve, an evaporator and a compressor of a refrigeration circuit, and a heat exchanger in thermal communication with the organic liquid in the pressure vessel of the warm section of the organic fluid circuit.

36. The thermal energy to hydropower system of claims 1 and 35, wherein the superheat vapor outlet of the said compressor passes through the said heat exchanger in thermal communication with the liquid of the pressure vessel of the warm section, and is transferred in to the pressure vessel of the warm section.

37. The thermal energy to hydropower system of claims 1, 35 and 36, wherein the latent heat of the said superheat vapor is transferred to the organic liquid of the pressure vessel of the warm section, where it generates saturated vapor.

38. The thermal energy to hydropower system of claims 1 and 35, wherein an alternative design eliminates the pressure vessel of the warm section of the organic fluid circuit, the heat exchanger in thermal communication with pressure vessel of the warm section and the liquid feed pump of the organic fluid circuit.

39. The thermal energy to hydropower system of claims 1, 35 and 38, wherein the superheat outlet of the said compressor is the direct inlet of the vapor pressure to hydro pressure convertor unit.
